(19) United States
(12) Patent Application Publication
(10) Pub. No.: US 2026/0323383 A1
(43) Pub. Date: Oct. 15, 2026

(54) Communication Method and Communication Apparatus

(71) Applicant: HUAWEI TECHNOLOGIES CO., LTD., Shenzhen (CN)

(72) Inventors: Ying Chen, Hangzhou (CN); Ruonan Yang, Shenzhen (CN); Jun Wang, Hangzhou (CN)

(73) Assignee: HUAWEI TECHNOLOGIES CO., LTD., Shenzhen (CN)

(21) Appl. No.: 19/689,099

(22) Filed: May 27, 2026

Related U.S. Application Data
(63) Continuation of application No. PCT/CN2024/133365, filed on Nov. 20, 2024.

(30) Foreign Application Priority Data
Nov. 28, 2023 (CN) 202311609498.7

(51) Int. Cl. H04W 28/02; H04W 72/21

(52) U.S. Cl. CPC H04W 28/0278; H04W 72/21

(57) ABSTRACT

A second apparatus sends first configuration information, where the first configuration information indicates a first uplink resource group, and the first uplink resource group is used to send uplink data corresponding to a buffer status report (BSR), to bind the BSR to a transmission resource of the corresponding uplink data. A first apparatus determines, in the first uplink resource group based on a first BSR associated with first data, one or more first uplink resources that are in the first uplink resource group and that are associated with the first BSR, and receives the first data on the one or more first uplink resources, thereby implementing semi-persistent scheduling (SPS) of a terminal in an Internet of things (IoT).

### CROSS-REFERENCE TO RELATED APPLICATIONS

This is a continuation of International Patent Application No. PCT/CN2024/133365 filed on Nov. 20, 2024, which claims priority to Chinese Patent Application No. 202311609498.7 filed on Nov. 28, 2023, which are hereby incorporated by reference in their entireties.

### TECHNICAL FIELD

This disclosure relates to the field of communication technologies, and in particular, to a communication method and a communication apparatus.

### BACKGROUND

In existing standards, uplink transmission based on semi-persistent scheduling (SPS) includes: a network side pre-configures periodic uplink resources, and terminals may send data on the semi-persistent resources based on services, to reduce scheduling signaling overheads. However, terminals in an Internet of things (IoT) currently support only buffer status report (BSR) reporting in the uplink transmission based on SPS and SPS acknowledgement feedback, and support dynamic scheduling-based data transmission. However, in a dynamic scheduling-based data transmission process, scheduling signaling overheads are high, leading to a reduction in a system capacity of the IoT.

### SUMMARY

This disclosure provides a communication method and a communication apparatus. In the method, a BSR is bound to a transmission resource of corresponding uplink data, thereby implementing SPS of a terminal in an IoT, and reducing signaling overheads of uplink data scheduling.

According to a first aspect, this disclosure provides a communication method. The method is performed by a first apparatus. The first apparatus may be a terminal (for example, a terminal in an IoT), or a component (for example, a processor, a chip, or a chip system) of a terminal, or may be a logical module that can implement all or a part of functions of a terminal. The first apparatus receives first configuration information, where the first configuration information indicates a first uplink resource group, and the first uplink resource group is used to send uplink data corresponding to a BSR. The first apparatus determines, in the first uplink resource group based on a first BSR associated with first data, one or more first uplink resources that are in the first uplink resource group and that are associated with the first BSR, to send the first data on the one or more first uplink resources.

In the method, a second apparatus may indicate the first uplink resource group to the first apparatus, to bind the BSR to a transmission resource of the corresponding uplink data, thereby implementing SPS of the terminal in the IoT, and reducing signaling overheads of uplink data scheduling.

In a possible implementation, the first uplink resource group includes one or more resource types, and each resource type corresponds to one or more BSRs.

In the method, the first uplink resource group may include different resource types, to correspond to different data. For example, if a data amount of the uplink data is small, the first apparatus may transmit the first data on a short-type resource; or if a data amount of the uplink data is large, the first apparatus may transmit the first data on a long-type resource, so that a waste of resources can be reduced.

In a possible implementation, the first apparatus sends the first BSR, where the first BSR is associated with the first data. Therefore, the first apparatus may activate, based on content of the first BSR, the one or more first uplink resources that are in the first uplink resource group and that correspond to the first BSR.

In the method, the first apparatus may determine, based on the first BSR, a resource configuration that needs to be activated, to implement the SPS and reduce the signaling overheads of the uplink data scheduling.

In a possible implementation, a start time point of the first uplink resource for sending the uplink data and a start time point or an end time point for sending the BSR meet a first mapping relationship.

In a possible implementation, the first apparatus receives second configuration information, where the second configuration information indicates the first mapping relationship.

In the foregoing method, the start time point of the resource for sending the uplink data is further limited, to avoid data collision. For example, the first mapping relationship may be predefined in a protocol, and the first apparatus has configured the first mapping relationship. When the uplink data needs to be sent, the first apparatus determines, based on the first mapping relationship, the start time point of the resource for sending the uplink data. Alternatively, the first mapping relationship is configured by a network side, and the network side delivers the second configuration information to indicate the first mapping relationship.

In a possible implementation, if a data amount of the first data is less than or equal to a quantity of preconfigured resources in the one or more first uplink resources, the first apparatus activates the corresponding resource.

In a possible implementation, if a data amount of the first data is greater than a quantity of preconfigured resources in the one or more first uplink resources, the first apparatus releases the one or more first uplink resources associated with the first data.

In the foregoing method, the first apparatus may determine, based on a data amount of uplink data, whether to activate a resource corresponding to the uplink data. For example, if the data amount of the uplink data does not match a quantity of preconfigured resources, the corresponding resource is released or not activated, to avoid a waste of resources.

In a possible implementation, if a data amount of the first data is greater than a quantity of preconfigured resources in the one or more first uplink resources, the first apparatus waits for scheduling information from the second apparatus to configure the corresponding uplink resource. For example, the second apparatus may reconfigure dynamic scheduling to indicate the corresponding uplink resource to the first apparatus; or the second apparatus reconfigures SPS, for example, reconfigures a group of uplink resources for the BSR.

In the method, when the uplink data does not match the preconfigured resource, the first apparatus may have a new resource used to send the uplink data.

In a possible implementation, before sending the first data on the first uplink resource, the first apparatus may receive first indication information, where the first indication information indicates that the first BSR has been successfully sent.

In the method, a piece of indication information is introduced, and the indication information indicates whether a network side successfully receives the BSR. For example, the first indication information may be downlink control information, and the first apparatus may perform detection on this type of downlink control information in a period of time after sending the BSR, to determine whether the network side successfully receives the BSR. This can improve reliability.

In a possible implementation, if the first indication information is not received, the first apparatus sends the first BSR again in a next scheduling periodicity.

In the method, if the first apparatus fails to receive the first indication information, it indicates that the network side does not successfully receive the BSR, and the first apparatus may continue to send the BSR on a next resource, to improve the reliability.

According to a second aspect, this disclosure provides a communication method. The method is performed by a second apparatus. The second apparatus may be a network device (for example, a base station), or a component (for example, a processor, a chip, or a chip system) of a network device, or may be a logical module that can implement all or a part of functions of a network device. The second apparatus sends first configuration information, where the first configuration information indicates a first uplink resource group, and the first uplink resource group is used to send uplink data corresponding to a BSR. The second apparatus receives a first BSR, and determines, in the first uplink resource group based on the first BSR, one or more first uplink resources that are in the first uplink resource group and that are associated with the first BSR. The second apparatus receives first data on the one or more first uplink resources.

In the method, the second apparatus may indicate the first uplink resource group to a first apparatus, to bind the BSR to a transmission resource of the corresponding uplink data, thereby implementing SPS of a terminal in an IoT, and reducing signaling overheads of uplink data scheduling.

In a possible implementation, a start time point of the first uplink resource for sending the uplink data and a start time point or an end time point for sending the BSR meet a first mapping relationship.

In a possible implementation, the second apparatus sends second configuration information, where the second configuration information indicates the first mapping relationship.

In the foregoing method, the start time point of the resource for sending the uplink data is further limited, to avoid data collision. For example, the first mapping relationship may be predefined in a protocol, and the first apparatus has configured the first mapping relationship. When the uplink data needs to be sent, the first apparatus determines, based on the first mapping relationship, the start time point of the resource for sending the uplink data, and the second apparatus does not need to configure the mapping relationship. Alternatively, the first mapping relationship is configured by the second apparatus, and the second apparatus delivers the second configuration information to indicate the first mapping relationship.

In a possible implementation, after receiving the first BSR, the second apparatus sends first indication information, where the first indication information indicates that the first BSR has been successfully received.

In the method, a piece of indication information is introduced, and the indication information indicates whether a network side successfully receives the BSR. For example, the first indication information may be downlink control information, and the second apparatus may send the first indication information after successfully receiving the BSR, to indicate, to the first apparatus, that the BSR has been successfully received. This can improve reliability.

According to a third aspect, this disclosure provides a communication method, and the method is implemented through interaction between a first apparatus and a second apparatus. For example, the first apparatus may be a terminal, and the second apparatus may be a network device. The communication method includes the following steps: the second apparatus sends first configuration information, where the first configuration information indicates a first uplink resource group, and the first uplink resource group is used to send uplink data corresponding to a BSR. Correspondingly, the first apparatus receives the first configuration information. The first apparatus sends a first BSR. Correspondingly, the second apparatus receives the first BSR, and determines, in the first uplink resource group based on the first BSR, one or more first uplink resources that are in the first uplink resource group and that are associated with the first BSR. The first apparatus sends first data on the one or more first uplink resources. Correspondingly, the second apparatus receives the first data on the one or more first uplink resources.

In the method, the second apparatus may indicate the first uplink resource group to the first apparatus, to bind the BSR to a transmission resource of the corresponding uplink data, thereby implementing SPS of a terminal in an IoT, and reducing signaling overheads of uplink data scheduling.

Optionally, for another implementation of the communication method, refer to corresponding descriptions in the first aspect and the second aspect. Details are not described herein again.

According to a fourth aspect, this disclosure provides a communication apparatus. The communication apparatus may be a terminal, a component (for example, a processor, a chip, or a chip system) of a terminal, or an apparatus that can be used together with a terminal. In a possible implementation, the communication apparatus may include a functional module. The functional module may be implemented by a hardware circuit, software, or a combination of a hardware circuit and software.

In a possible implementation, the communication apparatus includes a communication unit and a processing unit. The communication unit is configured to receive first configuration information, where the first configuration information indicates a first uplink resource group, and the first uplink resource group is used to send uplink data corresponding to a BSR. The processing unit is configured to determine, in the first uplink resource group based on a first BSR associated with first data, one or more first uplink resources that are in the first uplink resource group and that are associated with the first BSR. The communication unit is further configured to send the first data on the one or more first uplink resources.

In a possible implementation, the first uplink resource group includes one or more resource types, and each resource type corresponds to one or more BSRs.

In a possible implementation, the communication unit is configured to send the first BSR, where the first BSR is associated with the first data. The processing unit is configured to activate, based on content of the first BSR, the one or more first uplink resources that are in the first uplink resource group and that correspond to the first BSR.

In a possible implementation, a start time point of the first uplink resource for sending the uplink data and a start time point or an end time point for sending the BSR meet a first mapping relationship.

In a possible implementation, the communication unit is configured to receive second configuration information, where the second configuration information indicates the first mapping relationship.

In a possible implementation, if a data amount of the first data is less than or equal to a quantity of preconfigured resources in the one or more first uplink resources, the processing unit is configured to activate the corresponding resource.

In a possible implementation, if a data amount of the first data is greater than a quantity of preconfigured resources in the one or more first uplink resources, the processing unit is configured to release the one or more first uplink resources associated with the first data.

In a possible implementation, before sending the first data on the first uplink resource, the communication unit is configured to receive first indication information, where the first indication information indicates that the first BSR has been successfully sent.

In a possible implementation, if the first indication information is not received, the communication unit is configured to send the first BSR again in a next scheduling periodicity.

According to a fifth aspect, this disclosure provides a communication apparatus. The communication apparatus may be a network device, a component (for example, a processor, a chip, or a chip system) of a network device, or an apparatus that can be used together with a network device. In a possible implementation, the communication apparatus may include a functional module. The functional module may be implemented by a hardware circuit, software, or a combination of a hardware circuit and software.

In a possible implementation, the communication apparatus includes a communication unit and a processing unit. The communication unit is configured to send first configuration information, where the first configuration information indicates a first uplink resource group, and the first uplink resource group is used to send uplink data corresponding to a BSR. The communication unit is further configured to receive a first BSR. The processing unit is configured to determine, in the first uplink resource group based on the first BSR, one or more first uplink resources that are in the first uplink resource group and that are associated with the first BSR. The communication unit is further configured to receive first data on the one or more first uplink resources.

In a possible implementation, a start time point of the first uplink resource for sending the uplink data and a start time point or an end time point for sending the BSR meet a first mapping relationship.

In a possible implementation, the communication unit is configured to send second configuration information, where the second configuration information indicates the first mapping relationship.

In a possible implementation, after receiving the first BSR, the communication unit is configured to send first indication information, where the first indication information indicates that the first BSR has been successfully received.

For the fourth aspect and the fifth aspect, in an example, the processing unit may be a processor, and the communication unit may be a transceiver unit, a transceiver, or a communication interface. It may be understood that when the communication apparatus is a communication device (for example, a terminal or a network device), the communication unit may be a transceiver (for example, and the transceiver includes a transmitter and a receiver) in the communication apparatus, for example, implemented by using an antenna, a feeder, and a codec in the communication apparatus. If the communication apparatus is a chip disposed in a device, the processing unit may be a processing circuit, a logic circuit, or the like of the chip, and the communication unit may be an input/output interface of the chip, for example, an input/output circuit or a pin.

According to a sixth aspect, this disclosure provides a communication apparatus, including a processor, configured to execute instructions. Optionally, the communication apparatus further includes a memory. The memory is configured to store the instructions. When the instructions are executed by the processor, the communication apparatus is caused to implement at least one of the following: the method according to any one of the first aspect and the possible implementations of the first aspect, and the method according to any one of the second aspect and the possible implementations of the second aspect. Optionally, the processor is coupled to the memory.

According to a seventh aspect, this disclosure provides a communication system. The communication system includes at least one apparatus or device in the fourth aspect to the sixth aspect, to cause the at least one apparatus or device to perform at least one of the following: the method according to any one of the first aspect and the possible implementations of the first aspect, and the method according to any one of the second aspect and the possible implementations of the second aspect.

According to an eighth aspect, this disclosure provides a computer-readable storage medium, where the computer-readable storage medium stores instructions. When the instructions are run on a computer, the computer is caused to perform at least one of the following: the method according to any one of the first aspect and the possible implementations of the first aspect, and the method according to any one of the second aspect and the possible implementations of the second aspect.

According to a ninth aspect, this disclosure provides a computer program product, including instructions. When the instructions are run on a computer, the computer is caused to perform at least one of the following: the method according to any one of the first aspect and the possible implementations of the first aspect, and the method according to any one of the second aspect and the possible implementations of the second aspect.

According to a tenth aspect, this disclosure provides a chip, and the chip includes a processor (or a logic circuit). Optionally, the chip may further include a communication interface (or an interface), and is configured to implement at least one of the following: the method according to any one of the first aspect and the possible implementations of the first aspect, and the method according to any one of the second aspect and the possible implementations of the second aspect. In a possible implementation, if the chip is a minimum processing unit in an entire system, the chip may be a processor, may include a processor and a memory, or may include a processor, a memory, and a transceiver, and is configured to implement at least one of the following: the method according to any one of the first aspect and the possible implementations of the first aspect, and the method according to any one of the second aspect and the possible implementations of the second aspect.

According to an eleventh aspect, this disclosure provides a chip system. The chip system includes a processor and an interface. Optionally, the chip system may further include a memory, and is configured to implement at least one of the following: the method according to any one of the first aspect and the possible implementations of the first aspect, and the method according to any one of the second aspect and the possible implementations of the second aspect. The chip system may include a chip, or may include a chip and another discrete component.

### BRIEF DESCRIPTION OF DRAWINGS

FIG. 1 is a diagram of a communication system according to this disclosure;

FIG. 2 is a diagram of a scenario in which a communication method is applied to a satellite network communication system according to this disclosure;

FIG. 3 is a schematic flowchart of a communication method according to this disclosure;

FIG. 4 is a schematic flowchart of another communication method according to this disclosure;

FIG. 5 is a diagram of a communication apparatus according to this disclosure; and

FIG. 6 is a diagram of another communication apparatus according to this disclosure.

### DESCRIPTION OF EMBODIMENTS

In embodiments of this disclosure, “/” may represent an “or” relationship between associated objects. For example, A/B may represent A or B. “And/or” may be used to describe three relationships between the associated objects. For example, A and/or B may represent the following three cases: only A exists, both A and B exist, and only B exists, where A and B may be singular or plural. For ease of describing technical solutions in embodiments of this disclosure, in embodiments of this disclosure, words such as “first” and “second” may be used to distinguish between technical features with a same or similar function. The words such as “first” and “second” do not limit a quantity and an execution sequence, and the words such as “first” and “second” do not limit a definite difference. In embodiments of this disclosure, a word like “example” or “for example” indicates an example, an illustration, or descriptions. Any embodiment or design solution described as “example” or “for example” should not be explained as being more preferred or having more advantages than another embodiment or design solution. The word like “example” or “for example” is used to present a related concept in a specific manner for ease of understanding.

“Sending” and “receiving” in embodiments of this disclosure indicate signal transfer directions. For example, “sending information to the terminal” may be understood as a destination end of the information being the terminal device, and may include direct sending through an air interface, or indirect sending by another unit or module through an air interface. “Receiving information from a network device” may be understood as a source end of the information being the network device, and may include direct receiving from the network device through an air interface, or indirect receiving from the network device from another unit or module through an air interface. “Sending” may alternatively be understood as “outputting” of a chip interface, and “receiving” may alternatively be understood as “inputting” of a chip interface.

In other words, sending and receiving may be performed between devices, for example, between the network device and the terminal device; or may be performed inside a device, for example, sending or receiving between components, modules, chips, software modules, or hardware modules inside the device through a bus, a cable, or an interface.

It may be understood that necessary processing, such as encoding and modulation, may be performed on the information between the source end and the destination end of information sending, but the destination end may understand valid information from the source end. Similar descriptions in this disclosure may be understood similarly, and details are not described again.

In embodiments of this disclosure, “indication” may include a direct indication and an indirect indication, or may include an explicit indication and an implicit indication. Information indicated by a piece of information (for example, the following indication information) is referred to as to-be-indicated information. In a specific implementation process, the to-be-indicated information is indicated in a plurality of manners, for example, but not limited to, the following manners: The to-be-indicated information, for example, the to-be-indicated information or an index of the to-be-indicated information, may be directly indicated. Alternatively, the to-be-indicated information may be indirectly indicated by indicating other information. There is an association relationship between the other information and the to-be-indicated information. Alternatively, only a part of the to-be-indicated information may be indicated, and the other part of the to-be-indicated information is known or pre-agreed on. For example, specific information may be indicated by using an arrangement order of pieces of information that is pre-agreed on (for example, predefined in a protocol), to reduce indication overheads to some extent. A specific indication manner is not limited in this disclosure. It may be understood that, for a sender of the indication information, the indication information may indicate the to-be-indicated information, and for a receiver of the indication information, the indication information may be used to determine the to-be-indicated information.

The following describes the technical solutions in embodiments of this disclosure with reference to the accompanying drawings in embodiments of this disclosure.
I. For ease of understanding, the following describes in detail definitions of related nouns in this disclosure.

### 1. Communication System

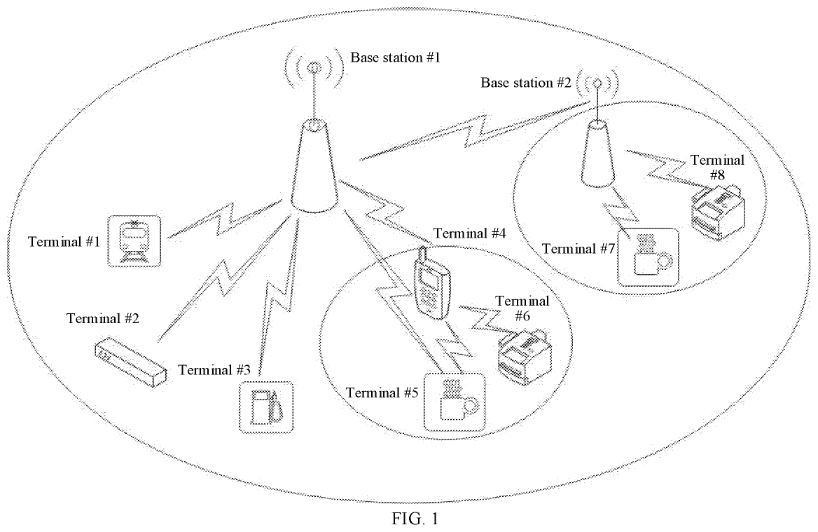

The communication method provided in this disclosure may be applied to a communication system shown in FIG. 1. For example, the communication system includes a network device and a terminal. In FIG. 1, only two network devices (for example, a base station #1 and a base station #2 in FIG. 1) and a plurality of terminals (for example, a terminal #1 to a terminal #8) are used as an example for description. A quantity of network devices and a quantity of terminals are not limited in this disclosure. For example, in the communication system, the base station #1 may send information to one or more terminals in the terminal #1 to the terminal #6. The base station #1 may send information to the terminal #7 and/or the terminal #8 via the base station #2. Optionally, the terminal #4 to the terminal #6 may also form a communication system. In the communication system, the terminal #5 may send information to the terminal #4 and/or the terminal #6. Optionally, the base station #2, the terminal #7, and the terminal #8 may also form a communication system. In the communication system, the base station #2 may send information to the terminal #7 and/or the terminal #8.

The communication system in this disclosure may include but is not limited to communication systems using various radio access technologies (RATs). For example, the communication system may be an IoT system, a Narrowband Internet of things (NB-IoT) system, a reduced capability/lightweight capability (RedCap) system, an IoT non-terrestrial network (NTN), a 5G (or referred to as New Radio (NR)) communication system, or a transition system between a Long-Term Evolution (LTE) communication system and a 5G communication system, where the transition system may also be referred to as a 4.5G communication system, or certainly may be a future communication system. A network architecture and a service scenario described in embodiments of this disclosure are intended to describe the technical solutions in embodiments of this disclosure more clearly, and do not constitute a limitation on the technical solutions provided in embodiments of this disclosure. A person of ordinary skill in the art may know that with evolution of communication network architectures and emergence of new service scenarios, the technical solutions provided in embodiments of this disclosure are also applicable to similar technical problems.

The terminal, also referred to as a terminal device, user equipment (UE), a mobile station (MS), a mobile terminal (MT), or the like, is a device that provides voice and/or data connectivity for a user, for example, a handheld device or a vehicle-mounted device having a wireless connection function. Currently, some examples of the terminal are: a mobile phone, a tablet computer, a notebook computer, a palmtop computer, a mobile Internet device (MID), a wearable device, an uncrewed aerial vehicle, a virtual reality (VR) device, an augmented reality (AR) device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, a terminal in a 5G network, a terminal in a future evolved network or a terminal in a future communication system, a low-cost and low-power-consumption terminal in a RedCap system, a passive Internet of things (Passive IoT) terminal, a terminal in an IoT NTN system, and the like.

The network device in this disclosure is a radio access network (RAN) node (or device) that connects the terminal to a wireless network, and may also be referred to as a base station. For example, some examples of the RAN node are: a continuously evolved NodeB (gNB), a transmission reception point (TRP), an evolved NodeB (eNB), a radio network controller (RNC), a NodeB (NB), a base station controller (BSC), a base transceiver station (BTS), a home base station (for example, a home evolved NodeB, or a home NodeB (HNB)), a baseband unit (BBU), a WI-FI access point (AP), a satellite in a satellite communication system, a radio controller in a cloud radio access network (CRAN) scenario, a wearable device, an uncrewed aerial vehicle, a device in an Internet of vehicles (for example, a vehicle-to-everything (V2X) device), a communication device in device-to-device (D2D) communication, or the like.

In a possible implementation, the network device may include a central unit (CU) node, a distributed unit (DU) node, or a RAN device including a CU node and a DU node. The RAN device including the CU node and the DU node splits protocol layers of an eNB in an LTE system. Functions of a part of protocol layers are centrally controlled by a CU, functions of a part or all of remaining protocol layers are distributed in a DU, and the CU centrally controls the DU. In some deployments of the network device, the CU may be further divided into a CU-control plane (CP), a CU-user plane (UP), and the like. In another possible implementation, the network device may alternatively be an antenna unit or the like. In another possible implementation, the network device may alternatively be of an open radio access network (ORAN) architecture or the like. A specific type of the network device is not limited in this disclosure. For example, when the network device is of the ORAN architecture, the network device in embodiments of this disclosure may be an access network device in an ORAN, a module in an access network device, or the like. In an ORAN system, a CU may also be referred to as an open central unit (O-CU), a DU may also be referred to as an open distributed unit (O-DU), a CU-DU may also be referred to as an open central unit-distributed unit (O-CU-DU), a CU-UP may also be referred to as an open central unit-user plane (O-CU-UP), and a radio unit may also be referred to as an open antenna unit (O-RU).

Optionally, signaling exchange in this disclosure may include but is not limited to one or more of the following: radio resource control (RRC) signaling exchange, medium access control (MAC) signaling exchange, physical layer (PHY) signaling and data exchange, and the like. For example, the RRC signaling exchange includes sending and receiving RRC signaling; the MAC signaling exchange includes sending and receiving MAC-CE signaling; and the PHY signaling and data exchange includes sending and receiving uplink/downlink control signaling, and/or sending and receiving uplink/downlink data.

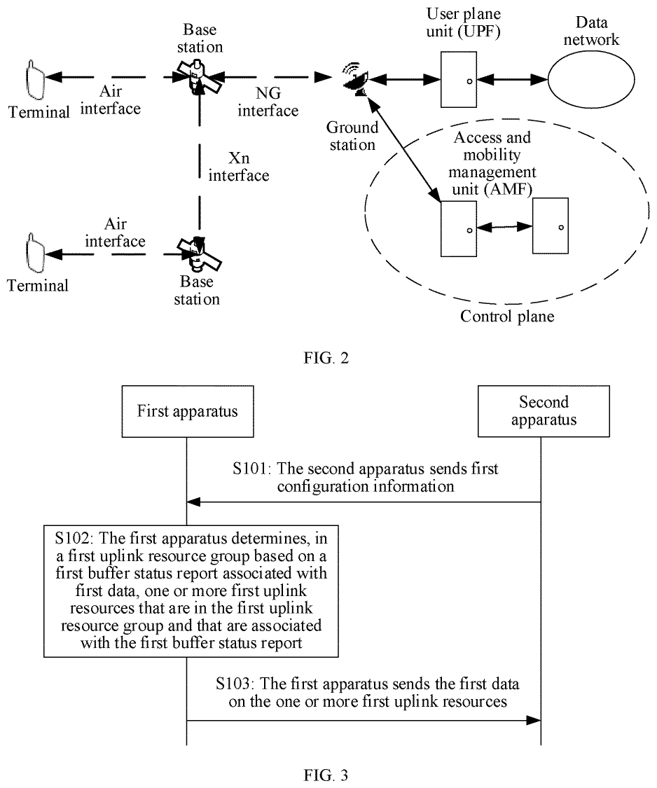

Optionally, the communication method provided in this disclosure may be further applied to a satellite network communication system. For example, FIG. 2 shows a typical application scenario of a satellite network. In this scenario, a terminal UE accesses a network through an air interface (the air interface may be various types of air interfaces, for example, a 5G air interface), and a base station is deployed on a satellite and is connected to a terrestrial core network through a radio link. In addition, there is a radio link between satellites, to complete signaling exchange and user data transmission between base stations. Network elements and interaction interfaces in the figure may include:
(1) The terminal includes a mobile device that supports NR, for example, any one of the foregoing terminal types. In this scenario, the terminal may access a satellite network through the air interface and initiate services such as a call and internet access.
(2) The base station mainly provides a wireless access service, schedules a radio resource for an access terminal, and provides a reliable wireless transmission protocol, a data encryption protocol, and the like, for example, any one of the foregoing base station types.
(3) The core network provides services such as user access control, mobility management, session management, user security authentication, and charging. The core network may include a plurality of functional units, which may be classified into a control plane functional entity and a data plane functional entity. For example, an access and mobility management unit (AMF) is responsible for user access management, security authentication, and mobility management. A user plane unit (UPF) is responsible for functions such as managing user plane data transmission and traffic statistics.
(4) A ground station is responsible for forwarding signaling and service data between a satellite base station and the core network.
(5) The air interface is a radio link between the terminal and the base station.
(6) An Xn interface is an interface between the base stations, and is mainly used for signaling exchange such as handover.
(7) An NG interface is an interface between the base station and the core network, and is mainly for exchange of signaling such as a non-access stratum (NAS) of the core network and service data of a user.

### 2. SPS Transmission Mechanism

In existing standards, SPS uplink transmission is: a network side pre-configures periodic uplink resources, and terminals may send data on semi-persistent resources based on services, to reduce scheduling signaling overheads. However, for terminals in an IoT, in a current design of the IoT, mainly in consideration that most services involve small-packet one-time transmission, the terminals do not stay in a connected state for a long time, there are few application scenarios of semi-persistent transmission of uplink data, and complexity of the terminals in the IoT is required to be low. As a result, SPS of the terminals in the IoT currently supports only BSR reporting and SPS acknowledgement feedback. For example, the terminals may report BSRs. Correspondingly, the network side receives the BSRs, and sends scheduling messages based on to-be-transmitted data of the terminals, to schedule uplink transmission (which may be considered as dynamic scheduling, and as a result, scheduling signaling overheads are high).

However, with changes and evolution of scenarios such as IoT NTN, long-term connections of the terminals need to be considered. New scenarios pose new requirements, for example, reducing scheduling signaling overheads of data scheduling to improve a system capacity.

Therefore, to resolve a problem that the existing terminals in the IoT do not support SPS of uplink data, this disclosure provides a communication method and a communication apparatus. The method can implement SPS of uplink data of the terminals in the IoT, and reduce scheduling signaling overheads.

II. Communication Methods Provided in this Disclosure
1. A communication method (first configuration information is indicated, and whether a network side successfully receives a BSR is not indicated) provided in this disclosure is as follows.

For example, FIG. 3 is a schematic flowchart of a communication method according to this disclosure. The method may be implemented through interaction between a first apparatus and a second apparatus. The first apparatus is, for example, a terminal or an apparatus of a terminal, and the second apparatus is, for example, a network device or an apparatus of a network device. The method includes the following steps.
S101: The second apparatus sends first configuration information. Correspondingly, the first apparatus receives the first configuration information.

The first configuration information indicates a first uplink resource group, and the first uplink resource group is used to send uplink data corresponding to a BSR. The first uplink resource group includes a plurality of first uplink resources. For example, it is assumed that the first uplink resource group includes N first uplink resources (for example, includes first uplink resources 1 to N), where N is a positive integer. Resources in the first uplink resource group are used to send the uplink data. For example, the N first uplink resources are used to send the uplink data. Optionally, the first configuration information may be carried in an RRC message.

Optionally, the first uplink resource group includes one or more resource types. For example, the one or more resource types may include but are not limited to one or more of the following resource types: resource size (size, which may also be referred to as data amount), transport block (TB) repeat number (for example, the uplink data may be completely sent through a plurality of repetitions of a TB), and modulation and coding scheme (MCS). In a possible implementation, the first uplink resource group may be represented in a form of a list. For example, Table 1 is a resource type table of the first uplink resource group. Table 1 is merely an example. The first uplink resource group may include three resource types shown in Table 1, or may include only two or one of the resource types. This is not limited in this disclosure.

TABLE 1
Resource type table of the first uplink resource group

| | Buffer size (BS) value | TB repeat | |
|---|---|---|---|
| Index | (in bytes) | number | MCS |
| 1 | size-1 | M1 | MCS-1 |
| 2 | size-2 | M2 | MCS-2 |
| . . . | . . . | . . . | . . . |

Each resource type includes a resource of the resource type. For example, when the resource type is BS, resources of the resource type include size-1, size-2, and the like. For another example, when the resource type is MCS, resources of the resource type include MCS-1, MCS-2, and the like. For specific content of MCS-1, MCS-2, and the like, refer to descriptions in an existing protocol (for example, a modulation scheme of MCS-1 is quadrature phase-shift keying (QPSK), and a coding rate is 1/3). Details are not described herein.

Optionally, each resource type corresponds to one or more BSRs. For example, for uplink data of different data sizes, it is assumed that the sizes of the uplink data may be classified into a long type and a short type. Assuming that a resource size corresponding to long in Table 1 is size-1, and a resource size corresponding to short in Table 1 is size-2, a resource type corresponding to the BSR is resource size. For another example, assuming that MCS types of the uplink data may be different types, another resource type corresponding to the BSR is MCS. In this case, each resource type may correspond to one or more BSRs, and each BSR may also correspond to one or more resource types.

Optionally, according to an operating principle of uplink SPS, the first apparatus first sends the BSR based on the to-be-sent uplink data (and then sends the uplink data). Correspondingly, the second apparatus receives the BSR. A resource for sending the BSR by the first apparatus may be predefined in a protocol, or may be preconfigured. For example, the second apparatus sends third configuration information to the first apparatus, where the third configuration information indicates a second uplink resource group, and the second uplink resource group is used by the first apparatus to send the BSR. A second uplink resource in the second uplink resource group carries a BSR value, and different BSR values are associated with different second uplink resources. Therefore, if the value of the BSR sent by the first apparatus includes a value range, the BSR value range may be associated with one second uplink resource, or may be associated with a plurality of second uplink resources.

Optionally, a relationship between the first uplink resource group and the BSR includes: one BSR is associated with one first uplink resource, or one BSR is associated with a plurality of first uplink resources. For example, Table 2 is an information table of the BSR, and Table 2 includes values (indexes) of reported BSRs and corresponding resource positions.

TABLE 2
Information table of the BSR

| | Resource position |
|---|---|
| Index | (including a time-frequency domain position) |
| 0 | Time-frequency domain position 1 |
| 1 | Time-frequency domain position 2 |
| . . . | . . . |

The BSR reported by the first apparatus actually indicates an index value in Table 2. Corresponding time-frequency domain position information may be obtained through query based on the index value, to determine a time-frequency domain resource position for sending the uplink data.

For another example, Table 3 is another information table of the BSR. Table 3 includes values (indexes) of reported BSRs and corresponding BS values.

TABLE 3
Another information table of the BSR

| Index | BS value (in bytes) |
|---|---|
| 0 | BS = 0 |
| 1 | 0 < BS <= 10 |
| 2 | 10 < BS <= 12 |
| 3 | 12 < BS <= 14 |
| 4 | 14 < BS <= 17 |
| 5 | 17 < BS <= 19 |
| 6 | 19 < BS <= 22 |
| 7 | 22 < BS <= 26 |
| 8 | 26 < BS <= 31 |
| 9 | 31 < BS <= 36 |
| 10 | 36 < BS <= 42 |
| 11 | 42 < BS <= 49 |
| 12 | 49 < BS <= 57 |
| 13 | 57 < BS <= 67 |
| 14 | 67 < BS <= 78 |
| 15 | 78 < BS <= 91 |
| 16 | 91 < BS <= 107 |
| 17 | 107 < BS <= 125 |
| 18 | 125 < BS <= 146 |
| 19 | 146 < BS <= 171 |
| 20 | 171 < BS <= 200 |
| 21 | 200 < BS <= 234 |
| 22 | 234 < BS <= 274 |
| 23 | 274 < BS <= 321 |
| 24 | 321 < BS <= 376 |
| 25 | 376 < BS <= 440 |
| 26 | 440 < BS <= 515 |
| 27 | 515 < BS <= 603 |
| 28 | 603 < BS <= 706 |
| 29 | 706 < BS <= 826 |
| 30 | 826 < BS <= 967 |
| 31 | 967 < BS <= 1132 |
| 32 | 1132 < BS <= 1326 |
| 33 | 1326 < BS <= 1552 |
| 34 | 1552 < BS <= 1817 |
| 35 | 1817 < BS <= 2127 |
| 36 | 2127 < BS <= 2490 |
| 37 | 2490 < BS <= 2915 |
| 38 | 2915 < BS <= 3413 |
| 39 | 3413 < BS <= 3995 |
| 40 | 3995 < BS <= 4677 |
| 41 | 4677 < BS <= 5476 |
| 42 | 5476 < BS <= 6411 |
| 43 | 6411 < BS <= 7505 |
| 44 | 7505 < BS <= 8787 |
| 45 | 8787 < BS <= 10287 |
| 46 | 10287 < BS <= 12043 |
| 47 | 12043 < BS <= 14099 |
| 48 | 14099 < BS <= 16507 |
| 49 | 16507 < BS <= 19325 |
| 50 | 19325 < BS <= 22624 |
| 51 | 22624 < BS <= 26487 |
| 52 | 26487 < BS <= 31009 |
| 53 | 31009 < BS <= 36304 |
| 54 | 36304 < BS <= 42502 |
| 55 | 42502 < BS <= 49759 |
| 56 | 49759 < BS <= 58255 |
| 57 | 58255 < BS <= 68201 |
| 58 | 68201 < BS <= 79846 |
| 59 | 79846 < BS <= 93479 |
| 60 | 93479 < BS <= 109439 |
| 61 | 109439 < BS <= 128125 |
| 62 | 128125 < BS <= 150000 |
| 63 | BS > 150000 |

The BSR reported by the first apparatus actually indicates an index value in Table 3. It can be learned from Table 3 that a TB size corresponding to BSR reporting falls within a range, instead of being a determined value. Therefore, when configuring resources, a network side may configure a plurality of first uplink resources for one BSR value (in other words, one BSR is associated with a plurality of first uplink resources), and one of the first uplink resources may also correspond to different BSR values.

For example, it can be learned from Table 3 that, when BSR=1, a corresponding BS falls within 0 to 80 bits (excluding 0 bits); or when BSR=2, a corresponding BS falls within 80 to 96 bits (excluding 80 bits). It is assumed that the first uplink resource group includes three first uplink resources: a configuration resource 1, a configuration resource 2, and a configuration resource 3. The configuration resource 1 includes two TBs, each TB has a size of 88 bits and occupies four resource units (RUs), and each RU occupies two slots. In this case, the configuration resource 1 occupies a total of 2*4*2=16 slots in time domain. The configuration resource 2 includes four TBs, each TB has a size of 32 bits and occupies two RUs, and each RU occupies two slots. In this case, the configuration resource 2 occupies a total of 2*2*4=16 slots in time domain. The configuration resource 3 includes two TBs, each TB has a size of 88 bits and occupies one RU. In this case, the configuration resource 3 occupies a total of 2*1*2=4 slots in time domain. Based on the foregoing assumptions, a size of a TB that can be carried on each of the configuration resource 1 and the configuration resource 3 is 88*2=176 bits=22 bytes. In this case, the configuration resource 1 and the configuration resource 3 may be associated with BSR=6, or may be associated with a BSR value<6. A size of a TB that can be carried on the configuration resource 2 is 32*4=128 bits=16 bytes. In this case, the configuration resource 2 may be associated with BSR=4. Optionally, although sizes of TBs carried on the configuration resource 1 and the configuration resource 2 are different and corresponding BSR values are different, sizes of occupied resources are the same, and the occupied resources may be a same time domain resource.

Optionally, a relationship between the first uplink resource and the second uplink resource includes: one second uplink resource is associated with a plurality of first uplink resources. For example, assuming that each first uplink resource is associated with one resource type, one second uplink resource is associated with a plurality of first uplink resources (in other words, associated with a plurality of resource types).
S102: The first apparatus determines, in the first uplink resource group based on a first BSR associated with first data, one or more first uplink resources that are in the first uplink resource group and that are associated with the first BSR.

Each piece of uplink data is associated with one BSR. For example, the first apparatus reports a BSR (for example, the first BSR) based on to-be-sent data (for example, the first data). According to the descriptions in S101, the first apparatus knows the first uplink resource group. In this case, the first apparatus may select one or more corresponding first uplink resources (resources such as resource size and MCS) from the first uplink resource group based on the first BSR (for example, determine a size of a corresponding TB based on a BSR value of the first BSR, to determine information such as an index value of the first uplink resource associated with the BSR).
S103: The first apparatus sends the first data on the one or more first uplink resources. Correspondingly, the second apparatus receives the first data on the corresponding first uplink resource.

The one or more first uplink resources may include a resource of one or more resource types. For example, the first apparatus sends the first data on a plurality of first uplink resources, where the plurality of first uplink resources include a TB repeat number resource, an MCS resource, and the like. Correspondingly, the second apparatus determines, based on the BSR (for example, based on information such as a BSR type and a BSR value), the first uplink resource for receiving the first data. Optionally, the second apparatus may further perform operations such as demodulation and decoding on the received first data based on the MCS resource.

Optionally, a start time point of the first uplink resource for sending the uplink data and a start time point or an end time point for sending the BSR meet a first mapping relationship. For example, assuming that the first uplink resource for sending the uplink data includes resources of resource types 1 and 2, a time domain start point of the resources of the resource types 1 and 2 is a start time point or an end time point of an uplink subframe for sending the BSR; or a time domain start point of the resources of the resource types 1 and 2 is a time point after a period of offset time elapses from a start time point or an end time point of an uplink subframe for sending the BSR. The offset may be set to a time delay from sending the data by the first apparatus to receiving the data by the second apparatus, or may be indicated by using indication information. For example, if the second apparatus sends first indication information to the first apparatus, and the first indication information indicates that the first BSR has been successfully received, a value of the offset may be a time delay after the first BSR is successfully received.

Optionally, the first mapping relationship may be predefined in a protocol. For example, at least one of a time domain relationship or a frequency domain relationship in the first mapping relationship is preconfigured in the protocol. It is assumed that the first mapping relationship is set to a fixed time domain relationship or a fixed frequency domain relationship (for example, an absolute value of a fixed time difference is preconfigured, or a fixed offset plus an absolute value of a fixed time difference is preconfigured).

Optionally, the first mapping relationship may be configured by the second apparatus. For example, the second apparatus sends second configuration information to the first apparatus. Correspondingly, the first apparatus receives the second configuration information, where the second configuration information indicates the first mapping relationship. Optionally, the second configuration information may be carried in an RRC message.

In this embodiment, the second apparatus may indicate the first uplink resource group to the first apparatus, to bind the BSR to the transmission resource of the corresponding uplink data, thereby implementing SPS of a terminal in an IoT, and reducing signaling overheads of uplink data scheduling.
2. Another communication method (first configuration information is indicated, and whether a network side successfully receives a BSR is indicated) provided in this disclosure is as follows.

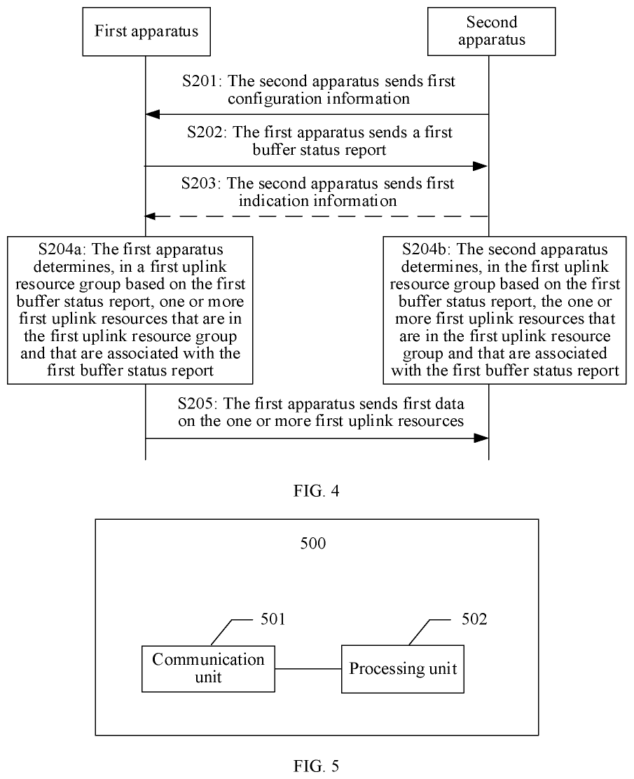

For example, FIG. 4 is a schematic flowchart of another communication method according to this disclosure. The method may be implemented through interaction between a first apparatus and a second apparatus. The first apparatus is, for example, a terminal or an apparatus of a terminal, and the second apparatus is, for example, a network device or an apparatus of a network device. The method includes the following steps.
S201: The second apparatus sends first configuration information. Correspondingly, the first apparatus receives the first configuration information.

For a specific implementation of S201, refer to corresponding descriptions in S101. For example, the first configuration information indicates a first uplink resource group, and the first uplink resource group may include a plurality of resource types shown in Table 1 and resources of the resource types. Details are not described herein again.
S202: The first apparatus sends a first BSR. Correspondingly, the second apparatus receives the first BSR.

According to the corresponding descriptions in S101, a second uplink resource group is used to send a BSR, and the second uplink resource group also includes one or more second uplink resources. Therefore, the first apparatus sends the first BSR on one or more second uplink resources associated with the BSR, where the first BSR is associated with first data.
S203: The second apparatus sends first indication information. Correspondingly, the first apparatus receives the first indication information.

For the second apparatus, the first indication information indicates that the first BSR has been successfully received. For the first apparatus, the first indication information indicates that the first BSR has been successfully sent. For example, if successfully receiving the first BSR, the second apparatus sends the first indication information to the first apparatus, to indicate that the first BSR has been successfully received. Correspondingly, the first apparatus receives the first indication information, to determine that the first apparatus has successfully sent the first BSR.

In a possible implementation, the first indication information is downlink control information (DCI). Specific implementations in which the first indication information is the DCI include the following several cases.
(1) A DCI format in an existing protocol is reused for the first indication information, and a spare field in the existing DCI format is used to carry the first indication information. For example, the second apparatus uses a spare field (assumed to be a 1-bit information field) in the existing DCI format to indicate whether the first BSR is successfully received. If a value of the information field is 0, it indicates that the first BSR is not successfully received; or if a value of the information field is 1, it indicates that the first BSR has been successfully received.
(2) A DCI format in an existing protocol is reused for the first indication information, and values of a part of information fields in the existing DCI format are set to a same value, to carry the first indication information. For example, if the second apparatus sets all values of a part of information fields (such as a DCI length field and a TB length field) in the existing DCI format to a same value (for example, all values are set to 1), it indicates that the first BSR has been successfully received. If values of a part of information fields remain unchanged (not set to a same value), it indicates that the first BSR is not successfully received.
(3) A new DCI format is used for the first indication information. For example, a new DCI format is designed, and the DCI format includes at least one first indication information field (assumed to be 1 bit). If a value of the first indication information field is 0, it indicates that the first BSR is not successfully received; or if a value of the information field is 1, it indicates that the first BSR has been successfully received.

It may be understood that when the first indication information is DCI, each piece of first indication information is indication information sent by the second apparatus to a corresponding first apparatus. In other words, in this case, the first indication information is a unicast message, and is sent only to the first apparatus that reports the BSR. In addition, when the first indication information is DCI, blind detection needs to be performed on the first indication information.

In another possible implementation, the first indication information is a system information block (SIB). In other words, in this case, the first indication information is a broadcast message. For example, in a network, a plurality of first apparatuses may simultaneously report BSRs. Correspondingly, the second apparatus receives the plurality of BSRs. The BSR may be reported based on a resource periodicity of the BSR. For example, the resource periodicity of the BSR has been specified in an existing protocol. It is assumed that resource periodicity is expressed in subframes, and a minimum periodicity is 128.

The second apparatus may reuse an existing SIB. For example, an information field is added to the SIB, and the information field carries the first indication information. The information field may carry the first indication information by carrying a bitmap. For example, the SIB carries a bitmap, and the bitmap is delivered in each subframe. A length of the bitmap is 12*M, where 12 is a quantity of subcarriers, and M is a quantity of slots. For example, it is assumed that a subcarrier spacing (SCS) is 15 kilohertz (kHz), and one subframe includes two slots. After sending the BSR to the second apparatus, the first apparatus receives the SIB after an offset of N subframes from a start subframe of the resource for the BSR, and reads the bitmap in the SIB. The bitmap is in a sequence of frequency domain first and then time domain. An information bit whose value is 1 in the bitmap indicates that a terminal initiates a BSR starting from the resource on the resource, and a value 0 indicates that the network side fails to receive the BSR.

It may be understood that, in this implementation, signaling overheads are reduced, and the terminal does not need to perform blind detection on the DCI, thereby reducing complexity of the terminal.

Optionally, if the second apparatus does not successfully receive the first BSR, S203 is not performed in the procedure (in other words, the second apparatus does not send the first indication information). Optionally, if the second apparatus does not successfully receive the first indication information, the first apparatus sends the first BSR again in a next scheduling periodicity.

The following describes specific implementation processes of S202 and S203 by using a specific example. First, the first apparatus sends the BSR based on the resource in the second uplink resource group configured by the second apparatus. The first apparatus performs detection on a narrowband physical downlink control channel (NPDCCH) after a period of time, for example, after a round-trip transmission delay. The physical downlink control channel (PDCCH) (for example, carrying the DCI) indicates whether the second apparatus successfully receives the BSR sent by the first apparatus. If the first apparatus detects no information from the network side, it indicates that the second apparatus does not successfully receive the BSR. The first apparatus may continue to send a current BSR value on a BSR resource in a next scheduling periodicity until the first apparatus detects the PDCCH corresponding to the second apparatus. After the first apparatus detects the PDCCH, a corresponding resource (bound to a resource reported in the BSR) used to send a physical uplink shared channel (PUSCH) takes effect. In this case, the first apparatus may send corresponding uplink data on the corresponding resource.
S204a: The first apparatus determines, in the first uplink resource group based on the first BSR, one or more first uplink resources that are in the first uplink resource group and that are associated with the first BSR.
S204b: The second apparatus determines, in the first uplink resource group based on the first BSR, the one or more first uplink resources that are in the first uplink resource group and that are associated with the first BSR.

The first apparatus or the second apparatus may determine, in the first uplink resource group associated with the BSR, the first uplink resource for sending or receiving the uplink data. For example, the first apparatus determines, based on the BSR value, a size of a corresponding TB, to determine information such as an index value of the first uplink resource associated with the BSR, and selects the one or more corresponding first uplink resources from the first uplink resource group.

Optionally, if a data amount of the first data is greater than a quantity of preconfigured resources in the one or more first uplink resources, the first apparatus releases the one or more first uplink resources associated with the first data. For example, if a size of a preconfigured resource does not meet a type of the BSR reported by the first apparatus, for example, a size of data that needs to be reported by the first apparatus exceeds the size of the preconfigured resource in the first uplink resource group, the corresponding resource is not activated or is released. Optionally, the first apparatus needs to wait for scheduling information from the second apparatus to configure the corresponding uplink resource. For example, the second apparatus may reconfigure dynamic scheduling to indicate the corresponding uplink resource to the first apparatus; or the second apparatus reconfigures SPS, for example, reconfigures a group of uplink resources for the BSR.

Optionally, if a data amount of the first data is less than or equal to a quantity of preconfigured resources in the one or more first uplink resources, the first apparatus activates the corresponding resource. Optionally, if a data amount of the first data is less than a quantity of preconfigured resources in the one or more first uplink resources, the first apparatus may perform a 0-padding operation for matching the quantity of preconfigured resources.
S205: The first apparatus sends the first data on the one or more first uplink resources. Correspondingly, the second apparatus receives the first data on the corresponding first uplink resource.

For a specific implementation of S205, refer to corresponding descriptions in S103. For example, the first apparatus sends the first data on a plurality of first uplink resources, where the plurality of first uplink resources include a TB repeat number resource, an MCS resource, and the like. A start time point of the first uplink resource for sending the uplink data and a start time point or an end time point for sending the BSR meet a first mapping relationship and the like. Details are not described herein again.

In this embodiment, the second apparatus may indicate the first uplink resource group to the first apparatus, to bind the BSR to the transmission resource of the corresponding uplink data, thereby implementing SPS of the terminal in an IoT, and reducing signaling overheads of uplink data scheduling. In addition, the second apparatus may feed back, to the first apparatus, whether the BSR is received, thereby improving reliability and reducing DCI detection overheads.

FIG. 5 is a diagram of a communication apparatus according to this disclosure. The apparatus may include modules that are in one-to-one correspondence with the methods/operations/steps/actions described in any embodiment shown in FIG. 3 and FIG. 4. The module may be implemented by using a hardware circuit, software, or a combination of a hardware circuit and software.

The apparatus 500 includes a communication unit 501 and a processing unit 502, configured to implement the methods performed by each device in the foregoing embodiments. The communication unit 501 is also referred to as a transceiver unit. The transceiver unit includes a sending unit and a receiving unit. The sending unit is configured to send a signal, and the receiving unit is configured to receive a signal.

In a possible implementation, the apparatus is, for example, a terminal or an apparatus of a terminal. The communication unit 501 is configured to receive first configuration information, where the first configuration information indicates a first uplink resource group, and the first uplink resource group is used to send uplink data corresponding to a BSR. The processing unit 502 is configured to determine, in the first uplink resource group based on a first BSR associated with first data, one or more first uplink resources that are in the first uplink resource group and that are associated with the first BSR. The communication unit 501 is further configured to send the first data on the one or more first uplink resources.

For specific execution procedures of the communication unit 501 and the processing unit 502 in this implementation, refer to descriptions of the steps performed by the first apparatus in the foregoing method embodiments and related descriptions. Details are not described herein again. In the communication method implemented by the apparatus, a network side may indicate the first uplink resource group to the terminal, to bind the BSR to a transmission resource of the corresponding uplink data, thereby implementing SPS of a terminal in an IoT, and reducing signaling overheads of uplink data scheduling.

In a possible implementation, the apparatus is, for example, a network device or an apparatus of a network device. The communication unit 501 is configured to send first configuration information, where the first configuration information indicates a first uplink resource group, and the first uplink resource group is used to send uplink data corresponding to a BSR. The communication unit 501 is further configured to receive a first BSR. The processing unit 502 is configured to determine, in the first uplink resource group based on the first BSR, one or more first uplink resources that are in the first uplink resource group and that are associated with the first BSR. The communication unit 501 is further configured to receive first data on the one or more first uplink resources.

For specific execution procedures of the communication unit 501 and the processing unit 502 in this implementation, refer to descriptions of the steps performed by the second apparatus in the foregoing method embodiments and related descriptions. Details are not described herein again. In the communication method implemented by the apparatus, a network side may indicate the first uplink resource group to a terminal, to bind the BSR to a transmission resource of the corresponding uplink data, thereby implementing SPS of a terminal in an IoT, and reducing signaling overheads of uplink data scheduling.

In a possible implementation, when the communication apparatus is a chip, the chip includes a transceiver unit and a processing unit. The transceiver unit may be an input/output circuit or a communication interface. The processing unit is a processor, a microprocessor, an integrated circuit, or a logic circuit integrated on the chip.

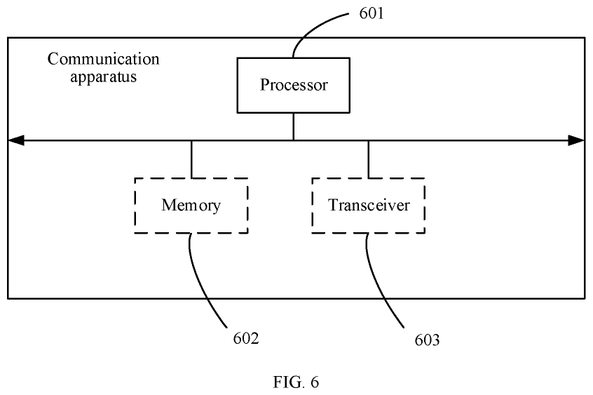

This disclosure further provides a communication apparatus. FIG. 6 is a diagram of another structure of a communication apparatus according to an embodiment of this disclosure. The communication apparatus may be configured to perform the steps performed by the first apparatus or the second apparatus in the foregoing method embodiments. For details, refer to related descriptions in the foregoing method embodiments.

The communication apparatus includes a processor 601. Optionally, the communication apparatus further includes a memory 602 and a transceiver 603.

In a possible implementation, the processor 601, the memory 602, and the transceiver 603 are separately connected through a bus, and the memory stores computer instructions. Optionally, the processor 601 and the memory 602 may alternatively be integrated together.

Optionally, the processing unit 502 in the foregoing embodiment may be the processor 601 in this embodiment. Therefore, specific implementation of the processor 601 is not described again. The communication unit 501 in the foregoing embodiment may be the transceiver 603 in this embodiment. Therefore, specific implementation of the transceiver 603 is not described again.

In this disclosure, the processor may be a general-purpose processor, a digital signal processor, an application-specific integrated circuit, a field programmable gate array, another programmable logic device, a discrete gate, a transistor logic device, or a discrete hardware component, and can implement or execute the methods, steps, and logical block diagrams disclosed in this disclosure. The general-purpose processor may be a microprocessor or any processor or the like. The steps of the methods disclosed with reference to this disclosure may be directly performed and completed by a hardware processor, or may be performed and completed by a combination of hardware and a software module in the processor.

In this disclosure, the memory may be a non-volatile memory, for example, a hard disk drive (HDD) or a solid-state drive (SSD), or may be a volatile memory, for example, a random-access memory (RAM). The memory is any other medium that can carry or store expected program code in a form of instructions or a data structure and that can be accessed by a computer, but is not limited thereto. The memory in this disclosure may alternatively be a circuit or any other apparatus that can implement a storage function, and is configured to store program instructions and/or data.

This disclosure provides another communication apparatus. The device includes a processor and an interface. Optionally, the device further includes a memory. The processor is coupled to the memory. The processor is configured to read and execute computer instructions stored in the memory, to implement the communication methods in embodiments shown in FIG. 3 and FIG. 4.

An embodiment of this disclosure further provides a communication system. The communication system includes a first apparatus and a second apparatus. The first apparatus is configured to perform all or a part of the steps performed by the first apparatus in the foregoing embodiments. The second apparatus is configured to perform all or a part of the steps performed by the second apparatus in the foregoing embodiments.

This disclosure provides a computer-readable storage medium. The computer-readable storage medium stores a program or instructions. When the program or the instructions are run on a computer, the computer is caused to perform the communication methods in embodiments shown in FIG. 3 and FIG. 4.

This disclosure provides a computer program product. The computer program product includes instructions. When the instructions are run on a computer, the computer is caused to perform the communication methods in embodiments shown in FIG. 3 and FIG. 4.

This disclosure provides a chip or a chip system. The chip or the chip system includes at least one processor and an interface. The interface and the at least one processor are interconnected through a line. The at least one processor is configured to run a computer program or instructions, to perform the communication method in embodiments shown in FIG. 3 and FIG. 4.

The interface in the chip may be an input/output interface, a pin, a circuit, or the like.

The chip system may be a system on chip (SoC), a baseband chip, or the like. The baseband chip may include a processor, a channel encoder, a digital signal processor, a modem, an interface module, and the like.

In an implementation, the chip or the chip system described above in this disclosure further includes at least one memory, and the at least one memory stores instructions. The memory may be a storage unit inside the chip, for example, a register or a cache, or may be a storage unit (for example, a read-only memory (ROM) or a RAM) of the chip.

All or a part of the technical solutions provided in this disclosure may be implemented by using software, hardware, firmware, or any combination thereof. When software is used to implement the technical solutions, all or a part of the technical solutions may be implemented in a form of a computer program product. The computer program product includes one or more computer instructions. When the computer program instructions are loaded and executed on a computer, the procedures or functions according to this disclosure are all or partially generated. The computer may be a general-purpose computer, a dedicated computer, a computer network, a network device, a terminal, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, for example, a server or a data center, integrating one or more usable media. The usable medium may be a magnetic medium (for example, a floppy disk, a hard disk drive, or a magnetic tape), an optical medium (for example, a digital video disc (DVD)), a semiconductor medium, or the like.

In this disclosure, on a premise that there is no logical contradiction, mutual reference may be made between embodiments. For example, mutual reference may be made between methods and/or terms in method embodiments, mutual reference may be made between functions and/or terms in apparatus embodiments, and mutual reference may be made between functions and/or terms in apparatus embodiments and method embodiments.

It is clear that a person skilled in the art can make various modifications and variations to this disclosure without departing from the scope of this disclosure. In this way, this disclosure is intended to cover these modifications and variations of this disclosure provided that they fall within the scope of the claims of this disclosure and equivalent technologies thereof.

1. A communication method applied to a communication apparatus, wherein the communication method comprises:
receiving first configuration information indicating a first uplink resource group, wherein the first uplink resource group is usable for sending uplink data corresponding to a buffer status report;
determining, based on a first buffer status report associated with first data, one or more first uplink resources that are in the first uplink resource group and that are associated with the first buffer status report; and
sending the first data on the one or more first uplink resources.

2. The communication method of claim 1, wherein the first uplink resource group comprises one or more resource types, and wherein each of the one or more resource types corresponds to one or more buffer status reports.

3. The communication method of claim 1, wherein a first start time point of the one or more first uplink resources for sending the uplink data and a second start time point or an end time point for sending the first buffer status report meet a first mapping relationship.

4. The communication method of claim 3, further comprising receiving second configuration information indicating the first mapping relationship.

5. The communication method of claim 1, further comprising releasing, in response to a data amount of the first data being greater than a quantity of preconfigured resources in the one or more first uplink resources, the one or more first uplink resources.

6. The communication method of claim 1, further comprising activating, in response to a data amount of the first data being less than or equal to a quantity of preconfigured resources in the one or more first uplink resources, the one or more first uplink resources.

7. The communication method of claim 1, further comprising receiving, in response to a data amount of the first data being greater than a quantity of preconfigured resources in the one or more first uplink resources, scheduling information is used to configure the one or more first uplink resources.

8. A communication apparatus, comprising:
a memory configured to store instructions; and
at least one processor coupled to the memory and configured to execute the instructions to cause the communication apparatus to:
receive first configuration information indicating a first uplink resource group, wherein the first uplink resource group is usable for sending uplink data corresponding to a buffer status report;
determine, based on a first buffer status report associated with first data, one or more first uplink resources that are in the first uplink resource group and that are associated with the first buffer status report; and
send the first data on the one or more first uplink resources.

9. The communication apparatus of claim 8, wherein the first uplink resource group comprises one or more resource types, and wherein each of the one or more resource types corresponds to one or more buffer status reports.

10. The communication apparatus of claim 8, wherein a first start time point of the one or more first uplink resources for sending the uplink data and a second start time point or an end time point for sending the first buffer status report meet a first mapping relationship.

11. The communication apparatus of claim 10, wherein the at least one processor is further configured to execute the instructions to cause the communication apparatus to receive second configuration information indicating the first mapping relationship.

12. The communication apparatus of claim 8, wherein the at least one processor is further configured to execute the instructions to cause the communication apparatus to release, in response to a data amount of the first data being greater than a quantity of preconfigured resources in the one or more first uplink resources, the one or more first uplink resources.

13. The communication apparatus of claim 8, wherein the at least one processor is further configured to execute the instructions to cause the communication apparatus to activate, in response to a data amount of the first data being less than or equal to a quantity of preconfigured resources in the one or more first uplink resources, the one or more first uplink resources.

14. The communication apparatus of claim 8, wherein the at least one processor is further configured to execute the instructions to cause the communication apparatus to receive, in response to a data amount of the first data being greater than a quantity of preconfigured resources in the one or more first uplink resources, scheduling information to configure the one or more first uplink resources.

15. A computer program product comprising instructions that are stored on a non-transitory computer-readable storage medium and that, when executed by at least one processor, cause a communication apparatus to:
receive first configuration information indicating a first uplink resource group, wherein the first uplink resource group is usable for sending uplink data corresponding to a buffer status report;
determine, based on a first buffer status report associated with first data, one or more first uplink resources that are in the first uplink resource group and that are associated with the first buffer status report; and
send the first data on the one or more first uplink resources.

16. The computer program product of claim 15, wherein the first uplink resource group comprises one or more resource types, and wherein each of the one or more resource types corresponds to one or more buffer status reports.

17. The computer program product of claim 15, wherein a first start time point of the one or more first uplink resources for sending the uplink data and a second start time point or an end time point for sending the first buffer status report meet a first mapping relationship.

18. The computer program product of claim 17, wherein the at least one processor is further configured to execute the instructions to cause the communication apparatus to receive second configuration information indicating the first mapping relationship.

19. The computer program product of claim 15, wherein the at least one processor is further configured to execute the instructions to cause the communication apparatus to release, in response to a data amount of the first data being greater than a quantity of preconfigured resources in the one or more first uplink resources, the one or more first uplink resources.

20. The computer program product of claim 15, wherein the at least one processor is further configured to execute the instructions to cause the communication apparatus to activate, in response to a data amount of the first data being less than or equal to a quantity of preconfigured resources in the one or more first uplink resources, the one or more first uplink resources.
